(19) United States
(12) Patent Application Publication
(10) Pub. No.: US 2023/0356366 A1
(43) Pub. Date: Nov. 9, 2023

(54) Finger Grip Assist Mechanism

(71) Applicant: Angelique Munoz, Los Angeles, CA (US)

(72) Inventor: Angelique Munoz, Los Angeles, CA (US)

(21) Appl. No.: 17/661,748

(22) Filed: May 3, 2022

(51) Int. Cl. B25B 9/02

(52) U.S. Cl. CPC B25B 9/02

(57) ABSTRACT

The present disclosure provides a finger grip apparatus comprising a finger pad and thumb pad connected by a flexible bridge, each of the finger pad and thumb pad having a high friction inner surface arranged adjacent to and parallel with one another. A user may grip the edges of a plastic bag or the like between the finger pad and thumb pad and make a transverse motion to pry apart the edges of the bag's opening more easily.

### CROSS REFERENCES TO RELATED APPLICATIONS

The present application claims the benefit and priority of U.S. provisional application No. 63/266,713, filed Jan. 12, 2022.

### FIELD OF INVENTION

The present invention relates generally to apparatus for opening a bag. More specifically, the present invention relates to a device for providing improved grip to assist with in parting the edges of a disposable bag.

### BACKGROUND

In the present day, a large number of disposable bags and other plastics items are mass manufactured with very fine edges that are packed closely together, often being part of a roll of many bags appended to one another. The edges of the bags often also have a very low friction coefficient, making the task of prying the edges apart even more difficult.

As these bags have no built-in mechanism for separating their edges, and since their edges are so fine, it is an everyday occurrence for most people to have to wrestle with the edges of a bag—for example a bin bag, grocery bag, or dog waste bag—in order to actually access the interior. For those with weak or undexterous fingers this can be very challenging.

It would therefore be desirable to have a device to facilitate this process by providing the fingers of a user with improved grip. It is within this context that the present invention is provided.

### SUMMARY

The present disclosure provides a finger grip apparatus comprising a finger pad and thumb pad connected by a flexible bridge, each of the finger pad and thumb pad having a high friction inner surface arranged adjacent to and parallel with one another. A user may grip the edges of a plastic bag or the like between the finger pad and thumb pad and make a transverse motion to pry apart the edges of the bag's opening more easily.

Thus, according to one aspect of the present disclosure there is provided an apparatus for providing an improved grip, the apparatus comprising a finger pad and a thumb pad each formed of a material having a friction coefficient of 1 or greater, the finger pad and thumb pad each having a flat inner surface and an outer surface, and being connected by a flexible bridge configured such that the inner surface of the finger pad is adjacent and parallel with the inner surface of the thumb pad.

In some embodiments, the material is rubber and/or silicone.

In some embodiments, the entire apparatus is formed of the material.

In some embodiments, the finger pad has a first loop extending across the outer surface.

In some embodiments, the wherein the thumb pad has a first loop extending across the outer surface.

In some embodiments, the thumb pad is dimensioned larger than the finger pad to accommodate the difference in digit sizes.

In some embodiments, the flexible bridge comprises a loop for coupling to a key chain.

### BRIEF DESCRIPTION OF THE DRAWINGS

Various embodiments of the invention are disclosed in the following detailed description and accompanying drawings.

FIG. 1 illustrates an isometric perspective view of an example configuration of a finger grip apparatus according to the present disclosure.

FIG. 2 illustrates an isometric side view of the example configuration of the finger grip apparatus.

FIG. 3 illustrates an isometric frontal view of the example configuration of the finger grip apparatus.

FIG. 4 illustrates an isometric top-down view of the example configuration of the finger grip apparatus.

FIG. 5 illustrates the appropriate positioning of the hand of a user with respect to the finger grip apparatus for use in prying apart the opening of a bag.

FIG. 6 illustrates the appropriate hand motion of a user using the finger grip apparatus to pry open the opening of a bag.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

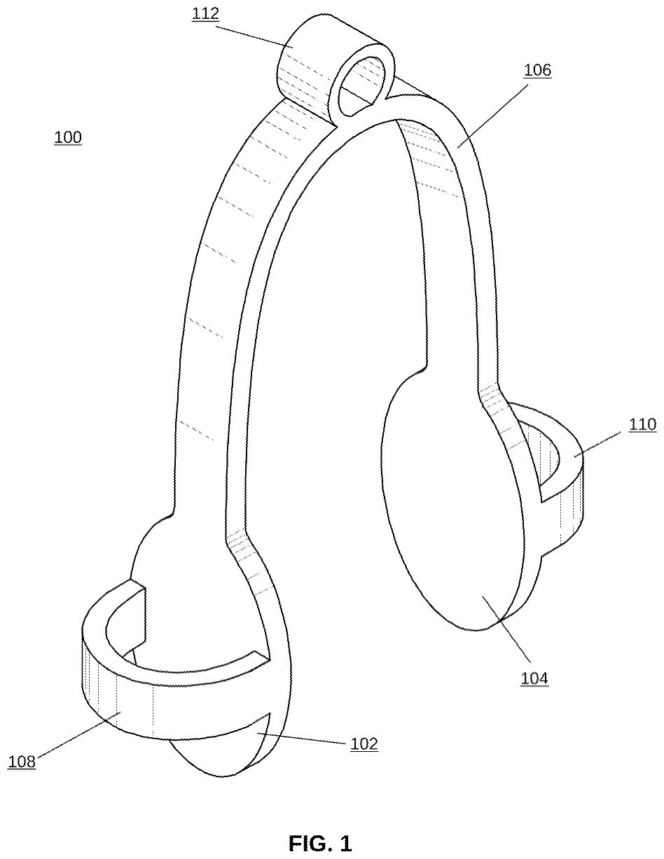

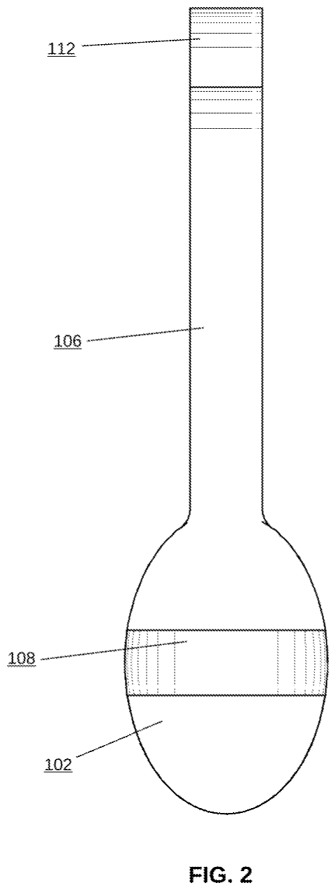

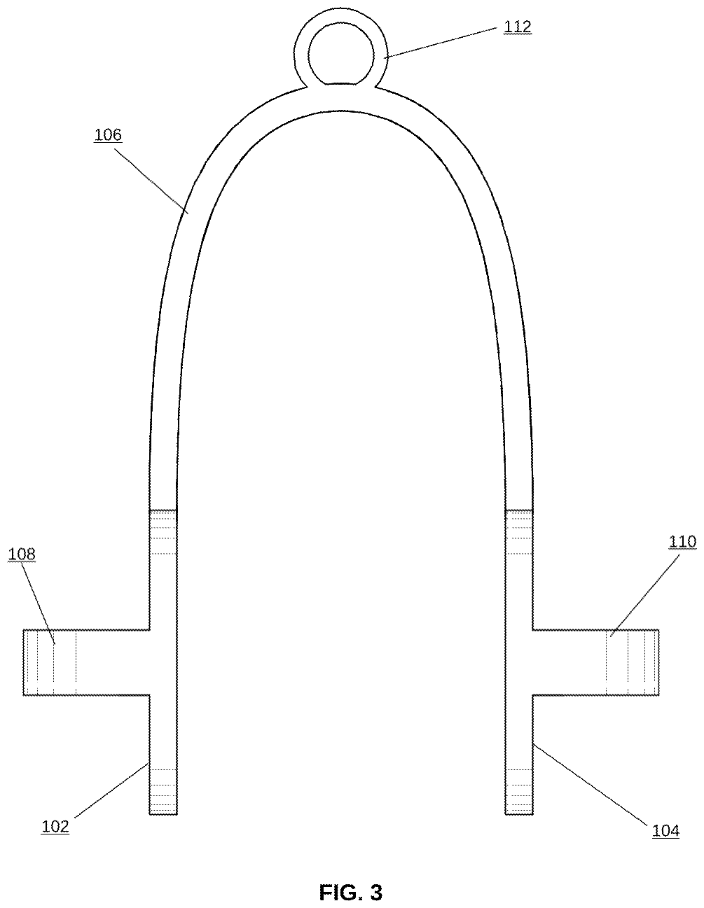

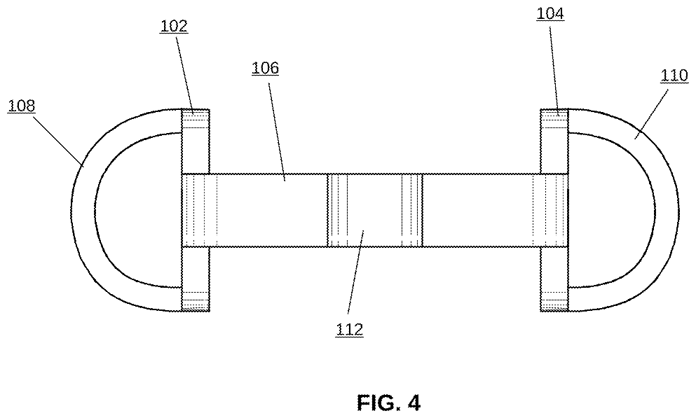

Referring to FIG. 1-FIG. 4, various isometric views of an example finger grip apparatus 100 according to the present disclosure are shown.

As can be seen, the example apparatus 100 comprises a finger pad 102 and a thumb pad 104 connected by a flexible bridge 106. Each of the finger pad 102 and the thumb pad 104 are comprised of a high friction-coefficient material such as silicone/rubber, and have a flat inner surface which is adjacent to and parallel with the inner surface of the opposing pad. These inner surfaces can be pinched together by a user to enclose and grip the outer edges of a plastic bag such as a dog waste bag.

The opposing outer surface of each pad is also mostly flat to allow for easy positioning of one's finger and thumb on them, and in the present example, both the outer surfaces of the finger pad and the thumb pad have a supporting band 108 and 110 spanning their width to keep the finger and thumb in position and prevent the user from dropping the apparatus 100.

Although not shown here, the finger pad 102 and the thumb pad 104 and their respective support bands/loops may be sized differently to compensate for the size difference between the average finger and thumb.

A loop 112 for coupling with a key chain is provided on the apex of the flexible bridge for portability and convenience. The flexible bridge itself helps with both portability and provides some supporting structure for the user's hand to apply the correct motion when opening a bag.

Although silicone and rubber are given as example materials for the pads it should be noted that other suitable materials may also be used. Any material having a friction coefficient above 1 is likely to be suitable. Furthermore, it may be that only the pads are formed of this material, or that portions of the apparatus or all of the apparatus are formed of it.

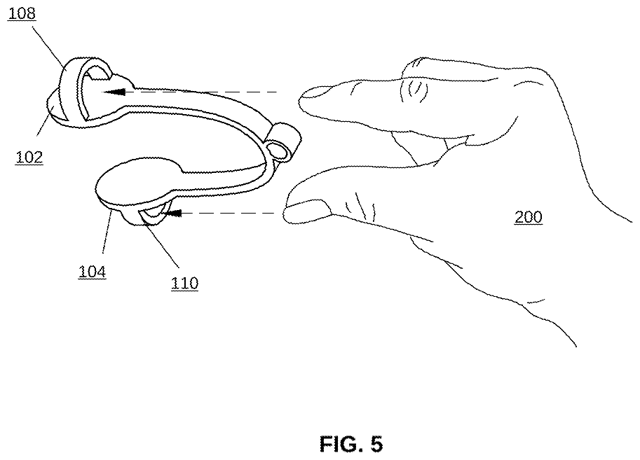

Referring to FIG. 5, the appropriate positioning of the hand 200 of a user with respect to the finger grip apparatus 100 is shown. As can be seen, the user places their hand 200 as if to pinch the two pads together, with their index finger or another finger slotting into the finger pad band and their thumb slotting into the thumb pad band.

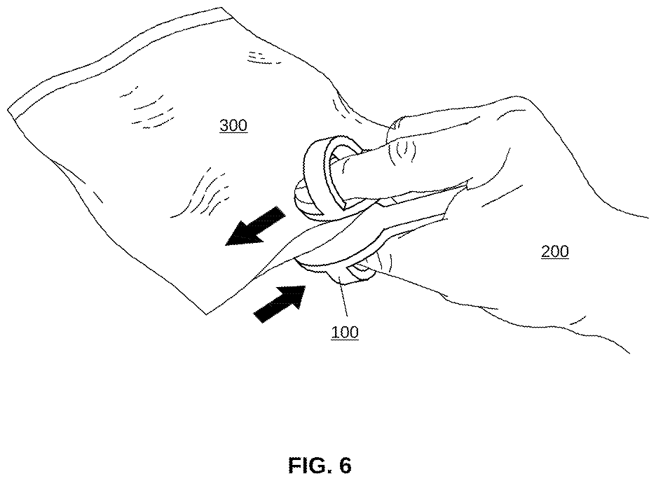

Referring to FIG. 6, the appropriate hand motion of a user using the finger grip apparatus 100 to pry open the opening of a bag 300 is shown. The user places their finger and thumb on the opposing pads and then pinches the bag opening between the inner surfaces of the finger and thumb pad, then applies a transverse motion with their finger moving one way and their thumb moving the other way, bending the flexible bridge in the process. The flat high-friction inner surfaces of the finger and thumb pads thus cause the opening of the bag 300 to be pried open with minimal application of force.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the finger grip apparatus have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. Apparatus for providing an improved grip, the apparatus comprising a finger pad and a thumb pad each formed of a material having a friction coefficient of 1 or greater, the finger pad and thumb pad each having a flat inner surface and an outer surface, and being connected by a flexible bridge configured such that the inner surface of the finger pad is adjacent and parallel with the inner surface of the thumb pad.

2. Apparatus according to claim 1, wherein the material is rubber and/or silicone.

3. Apparatus according to claim 1, wherein the entire apparatus is formed of the material.

4. Apparatus according to claim 1, wherein the finger pad has a first loop extending across the outer surface.

5. Apparatus according to claim 1, wherein the wherein the thumb pad has a first loop extending across the outer surface.

6. Apparatus according to claim 1, wherein the thumb pad is dimensioned larger than the finger pad to accommodate the difference in digit sizes.

7. Apparatus according to claim 1, wherein the flexible bridge comprises a loop for coupling to a key chain.
